(19) United States
(12) Patent Application Publication
(10) Pub. No.: US 2018/0369033 A1
(43) Pub. Date: Dec. 27, 2018

(54) SUPPORT CUSHION FOR SUPPORTING THE UNDERARM

(71) Applicant: PLUS-ULTRA-GLOBALBERATUNGSGESELLSCHAFT MBH, Berlin (DE)

(72) Inventors: Amelie ZUEHLKE, Meppen (DE); Rüdiger FLEISCH, Berlin (DE)

(21) Appl. No.: 16/064,654

(22) PCT Filed: Dec. 5, 2016
(86) PCT No.: PCT/EP2016/079717

§ 371 Date: Jun. 21, 2018

(30) Foreign Application Priority Data
Dec. 21, 2015 (DE) 10 2015 122 373.2

(51) Int. Cl. A61G 5/10; A61G 5/12; A61G 13/12

(52) U.S. Cl. CPC A61G 5/1091; A61G 13/124; A61G 5/125

(57) ABSTRACT

A support cushion for supporting a lower arm that includes an inner side facing towards the body with a concave shape and an outer side facing away from the body with a convex shape, and the upper side has a central seam that forms a recess, whereby the recess is bordered by side bulges

### CROSS REFERENCE TO RELATED APPLICATIONS

This application is a U.S. Nationalization of PCT Application Number PCT/EP2016/079717, filed on Dec. 5, 2016, which claims priority to German Patent Application No. 102015122373.2, filed on Dec. 21, 2015, the entireties of which are incorporated herein by reference.

The invention relates to a support cushion and is usable for the support of a lower arm, for example on the therapy table or arm rest of a wheelchair for patients with paralysis of the arm.

People with paralysis of the arm or half-sided paralysis after a stroke, brain haemorrhage or other traumatic brain injuries or damage are frequently placed in a wheelchair (mobilised) in hospital, a rehabilitation clinic or later at home, where they spend several hours each day. Generally, so-called therapy tables or affixed tables are attached to these wheelchairs, which on the one hand are designed to prevent unsupervised standing up or sliding off of the patient, while on the other enable food trays, cups, books or occupational and therapy materials to be placed on them.

The paralysed arm of the patient usually lies unprotected on the hard therapy table, or on a small pillow, towels or similar materials. However, this offers little protection or comfort.

Incorrect support entails the risk of further or new damage of the extremities. In particular in cases of central paralysation (due to injury to the nerves in the brain or spinal cord), a loss of sensitivity occurs, known as ‘neglect’. This means that the patient has no feeling in their paralysed arm, and occasionally also forgets it entirely (alien limb syndrome). As a result, folds in clothing, pressure areas and the hardness of the subsurface is not noticed, or is noticed too late, which leads to red patches and damage to the skin, and even to pressure sores (decubitus). Vegetative disorders associated with paralysis, such as increased sweating or swelling, or also fluids that are knocked over, increase the risk.

The function of support cushions comprises the comfortable support (cushioning) of a person's body parts. They are used for nursing or therapeutic purposes. A typical nursing purpose is for example the prevention and treatment of pressure sores and the reduction of pain.

The functional principle of a known support cushion is as follows:

Through the plurality of tiny filling elements, such as air-filled beads, in the cushion, the weight is distributed over many small units, so that pressure relief is enabled.

A support cushion is known from DE 202005016378 U1 which is suitable for supporting an arm, in which the arm can at least partially be laid in a moulded body, which is fitted with an L-shaped recess.

A therapeutic cushion is known from DE 19524488 A1, whereby said cushion is designed as a support for the head, whereby the basic body has a depression that points in the direction of the body for holding the cervical spinous process. A bead is arranged on each of the adjoining sides.

A therapeutic cushion is known from DE 202008015833 U1 which is designed to be placed on a chair, in particular a wheelchair, on the arm rests. It is characterised by the fact that it is longer than the distance between the arm rests, and thus affixes the person sitting in the chair.

DE 2601739 A1 describes a harness device for keeping the lower arm, wrist and hand of a patient still during intravenous treatments. The harness device is based on a rigid longitudinal element, which has an essentially convex surface, the form of which serves to support the normal hand-width side of the lower area of the lower arm, the wrist and the surface of the hand of a patient. Furthermore, the harness device has an essential concave surface, the form of which serves to support the normal rear side of the lower area of the lower arm, the wrist and the surface of the hand of the patient, so that the convex and concave areas extend over opposite sides of the longitudinal element, and the contours of the convex and concave areas are provided in a complementary alignment, as a result of which the longitudinal element is essentially given a concave-convex profile.

US 2014/0035802 A1 describes the affixation of a traumatised shoulder joint or arm, which can be suitable for use after injury, and which is conceived for standing patients.

The solution in U.S. Pat. No. 5,335,888 A stabilises the arm while working at the computer.

U.S. Pat. No. 4,210,317 A contains the affixing of a patient on an operating table. In GB 2156225 A, an affixing facility is also described.

The object of the invention is to create a device which has an anatomically optimised form, in order to considerably improve the support of the lower arm, including the elbow, and the hand, and at the same time to distribute the support pressure on the arm over soft parts as far as possible, and to relieve the burden on the elbow, whereby at the same time, the level of comfort is increased for the user. Additionally, an open support of the hand is to be achieved in order to counteract the formation of spasticity (cramping into a fist).

This object is attained by the features of the invention in claim 1. Advantageous embodiments of the invention are contained in the dependent claims.

With the present invention, through its anatomically adapted form, the support cushion enables stable support of an arm—such as a paralysed arm.

A particular advantage of the invention is that an inner side that faces towards the body has a concave design and an outer side facing away from the body has a convex design, and in the centre, there is a recess that is achieved by a central seam, whereby the recess is bordered by side bulges. As a result, the lower arm lying on the cushion, in particular in the places sensitive to pressure, sinks into the support cushion, leading to an increase in comfort and well-being for the user. At the same time, the recess reduces the pressure acting on the sensitive parts, as a result of which the risk of pressure marks, particularly when the arm lies for a long time, is considerably reduced. The support of the elbow according to the invention and thus a slight compression of the shoulder reduces pain and facilitates an upright posture. The central seam can be slightly curved towards the inner side.

A further particular advantage arises when the support cushion according to the invention is arrangeable on a solid surface. Such surfaces include, for example, the above therapy or affixed tables on wheelchairs. Through its anatomically adapted form, the invention enables stable support of the paralysed arm on the solid surface, and at the same time provides a solid and yet soft underlay, which considerably reduces the risk of the formation of pressure sores.

In one advantageous embodiment of the support cushion according to the invention, the cushion is adapted to the lower arm of the user in terms of its dimensions—length, breadth and width. The different dimensions thus meet the requirements of the user, increase ergonomics and further improve the comfort of the invention.

A further advantage is offered by the support cushion according to the invention when the cushion, on the part of the upper side that holds the elbow of the user, has a narrower rear side that differs from the remaining cushion breadth, and/or on the part of the upper side that holds the front lower arm of the user, has a broader upper front side that differs from the remaining cushion breadth. Thus, the support cushion saves more space (and is in particular optimised for use on the arm rest of a wheelchair), and for example permits the further use of a therapy table for occupation or nursing care without restrictions. The narrower rear side prevents a restriction of movement of the arm, while a broader front side increases the reliability of the stability on a solid surface, as well as improving comfort for the user.

A further advantage is offered by the soft and broad front side of the support cushion according to the invention for supporting the hand. In cases of limp paralysation, the hand can lie freely and openly on the cushion and is not impeded in its function and movement (e.g. during physiotherapy). With the onset of spasticity (paralysation with cramping to form a fist), the front part of the cushion with its soft, pliable consistency and adapted length can be grasped hold of by the first and ‘kneaded’. For example, this prevents the fingernails from being buried in the inner surface of the hand and leading to injury, and through the pliable resistance, the opening of the first is gently supported.

An advantageous embodiment of the support cushion according to the invention provides an inner cushion with or without a separate cover, wherein the central seam on the inner cushion and/or the support cushion is arranged without a cover. The cover can be replaced if it becomes dirty or damp, thus increasing the level of hygiene and longevity of the cushion. The covers are washable, regardless of the material, and protect the inner cushion against damp and dirt, and can create a more homey atmosphere with their decorative properties. The support cushion without separate cover consists of skin-friendly material with protection against becoming thoroughly damp, and fulfils all the properties described above, with its advantage lying in the simpler handling.

Advantageously, on the support cushion according to the invention, at least one fastening element can be arranged, which is firmly connected on the rear side and/or the edge of the outer side to the inner cushion and/or the cover. The connection between the fastening element and the inner cushion and/or cover can be designed through multiple seams and/or in another manner. As a result of this fastening element, the support cushion can for example be connected and affixed to a wheelchair arm rest. As a result, slippage is prevented.

In a further embodiment of the invention, at least two fastening elements, which are each firmly connected to the edges of the inner and outer side of the front side of the cushion and/or to the cover, are arranged on the cushion. The connection between the fastening elements and the inner cushion and/or the cover can be achieved through multiple seams and/or in another manner. As a result, the wrist, in particular for severely affected patients, can be loosely affixed onto the cushion in order to hinder a sliding off of the arm in cases of severe neglect. If the arm nevertheless slides off the therapy table with the cushion, it is considerably less likely that it will become wedged in the wheelchair. If the fastening elements are not used, these can be connected under the cushion so that they do not disturb the user, or they can advantageously also serve as a fastening with surfaces underneath (such as the arm rest of a wheelchair).

One or more of the fastening elements can be designed as a strip with or without a Velcro fastener, and/or as a strip consisting of material. A strip saves costs and at the same time enables a functional affixing option through binding. A Velcro fastener is practical and easy to handle. The material is low-cost and suitable for the application.

Advantageously, the material on the outer side of the inner cushion and/or the cover and/or the cushion without the cover can consist of cotton and/or coated molton cotton and/or is sewn with PE thread and/or is breathable. As a result, natural, environmentally friendly materials are used in particular. The material variants increase the skin compatibility and sense of touch when the lower arm is laid down—in particular when there is direct skin contact. This choice of material protects the skin against softening through increased sweating, and supports sensitivity through the comfortable surface. Due to the skin-compatible materials, allergic reactions are also prevented. The material can also further prevent the support cushion from slipping, in particular when the material is selected on the lower side of the support cushion.

In a further embodiment of the support cushion according to the invention, the material of the cushion filling consists of polystyrene micro-beads and/or spelt and/or polyester flock. As a result, the anatomical adaptability and therapeutic effect of the cushion is optimised. With a tendency towards spastic paralysis with cramping of the hand into a fist, the flexible filling of the cushion enables an open support. As a result, the function of the hand is improved, pain and injury through the patient's own fingernails are prevented, and hygiene is facilitated.

The invention will now be described in greater detail below with reference to exemplary embodiments shown at least partially in the figures, in which:

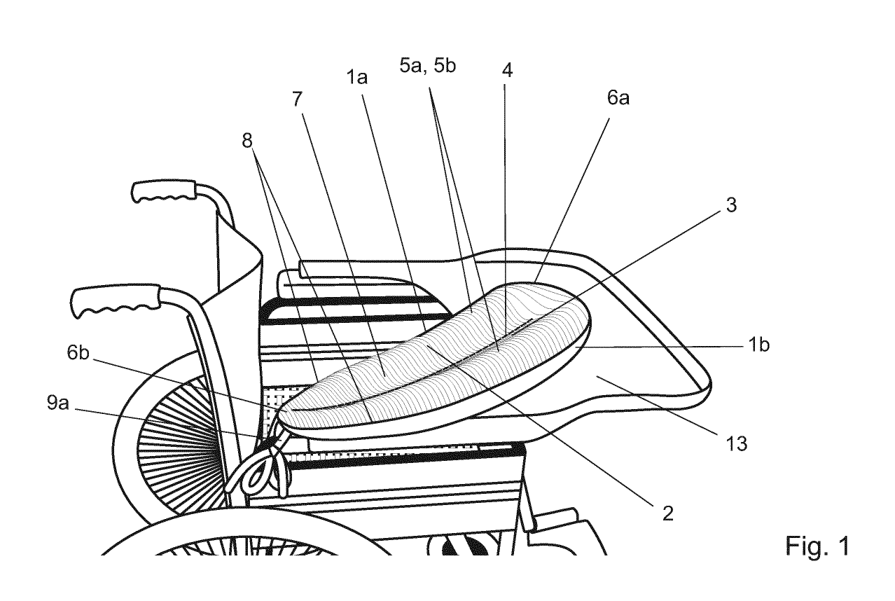

FIG. 1 shows the support cushion according to the invention from a diagonal side view, arranged on a therapy table of a wheelchair,

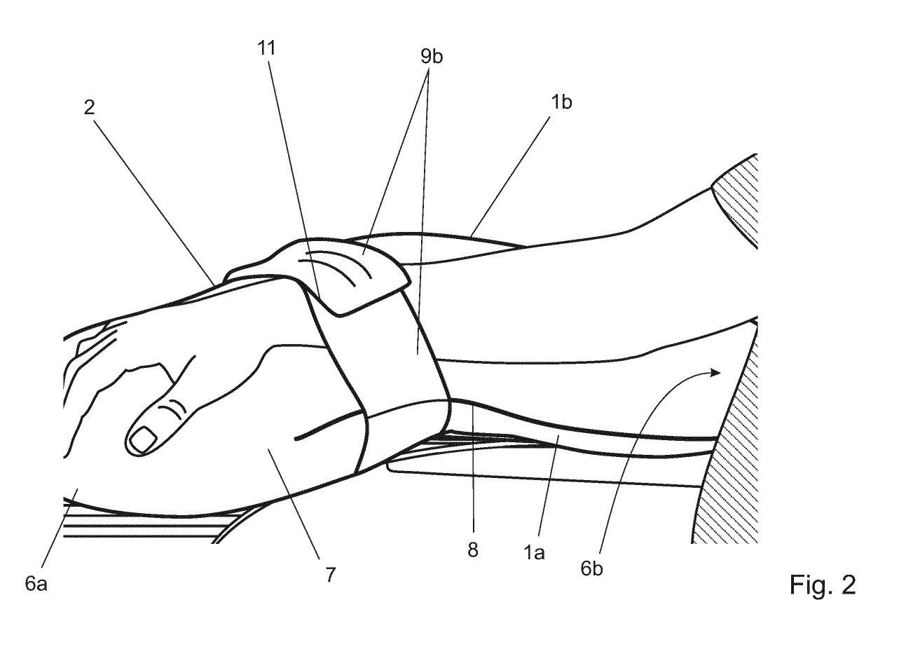

FIG. 2 shows the support cushion according to the invention from a diagonal side view with fastening elements,

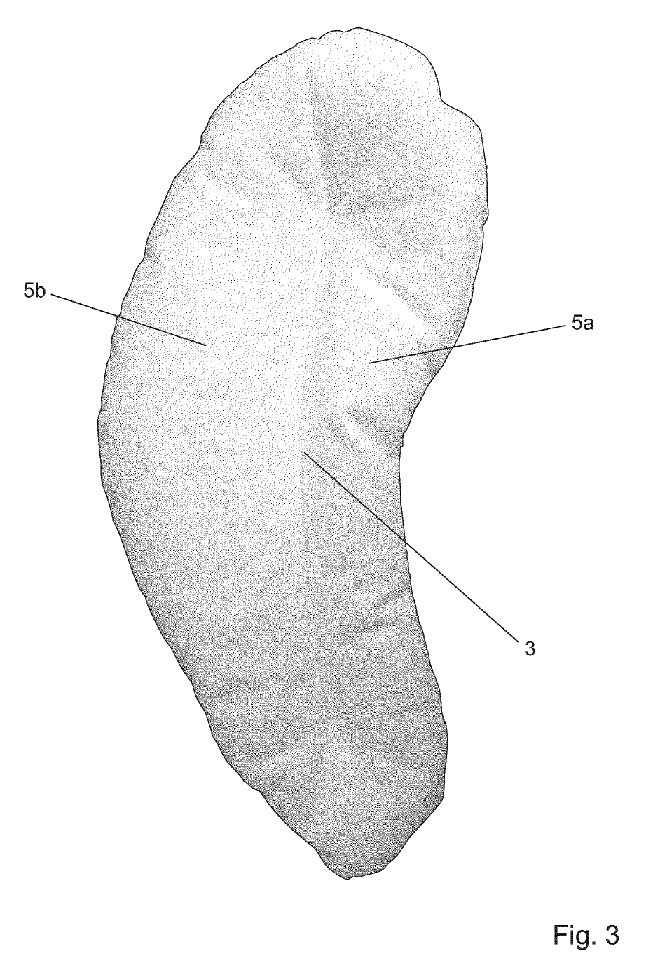

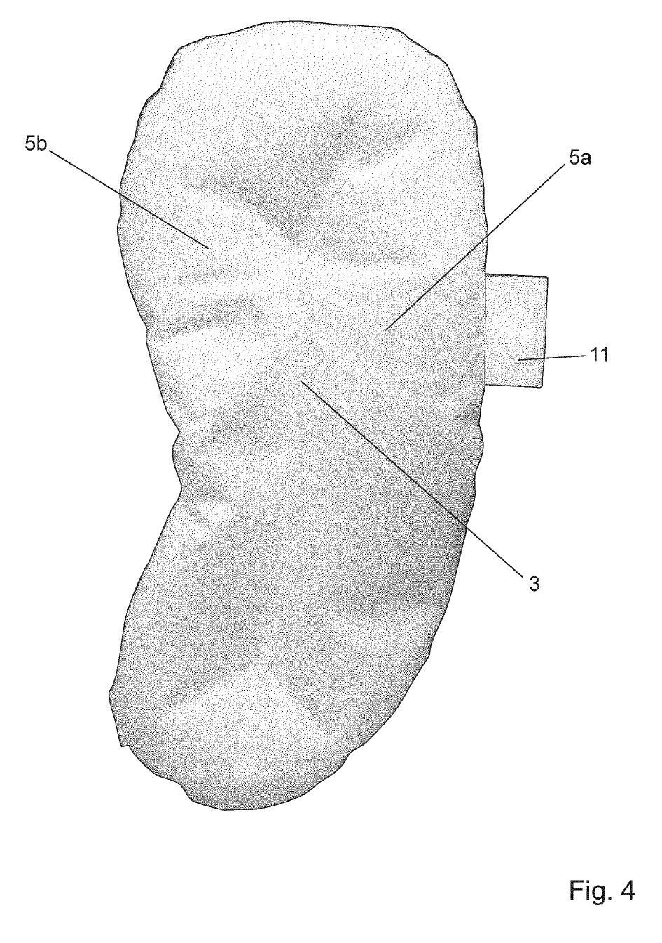

FIG. 3 and FIG. 4 show a plastic view of two embodiments of the support cushion.

FIG. 1 shows the support cushion according to the invention with a concave running inner side 1a and convex running outer side 1b, wherein in the central area of the upper side 2, a recess 3 runs. This is enabled by the central seam 4. In order to prevent a continued fold from being created, the central seam 4 has been bent over approximately 1.5 cm from the edge 8 on the rear side 6b by an angle of 15-20 degrees to the inner side 1a of the cushion, and has a double stitching for durability. At the side of the recess 3, bulges 5a, 5b are arranged. The length of the large inner cushion is approximately 60 cm, the breadth of the front side 6a is approximately 21 cm and the breadth of the rear side 6b is approximately 15 cm.

The support cushion is arranged in the exemplary embodiment on a therapy table of a wheelchair. Here, two fastening elements 9a (strips) have been attached to the rear side 6b of the support cushion. In this embodiment according to the invention, these are 3 cm wide and sufficiently long to find a firm hold through being bound to the arm rest of the wheelchair (binding variant). In the version shown in FIG. 1, the strips are 40 cm long. They are sewn into the rear side 6b of the cushion on the cover 7 in the side seam. In one variant, they can also be directly connected with the inner cushion or lightly connected on the concave side of the inner cushion or in the same place of the cover 7 by a seam or by other forms, such as a Velcro fastening or adhesion.

In a further embodiment, on the ends of the fastening elements 9a, a Velcro fastening is arranged, with which they can be bound to the arm rest of the wheelchair, for example (Velcro variant).

The support cushion is also arrangeable on other suitable surfaces 13.

The material of the cover 7 of this embodiment according to the invention is coated molton cotton. The cover is sewed with PE thread, and the edges 8 are trimmed. The material here is breathable. In other embodiments, other materials are also possible, which are suitable as materials for a support cushion according to the prior art. Depending on the functionality, different materials can be arranged in different places on the cushion.

FIG. 2 shows the support cushion according to the invention when the lower arm is laid on it. Here, the embodiment shows two fastening elements 9b, approximately 7×18 cm, which are firmly connected with the side seam on the edge 8 of the cover 7 through multiple seams. The fastening elements 9b have a Velcro fastening 11 on their ends (approximately 1.5 cm broad and 10 cm long). Starting approximately 2 cm from the end of the strip, the Velcro fastening is arranged in such a manner that on one strip, the Velcro side is arranged on the upper side 2, and on the other strip, the nap side is arranged on the lower side. The strips can be affixed one on top of the other both on the lower side and on the upper side 2 of the cushion or cover 7. The edge area on which the fastening elements 9b are sewn with the cover 7 lie approximately 30 cm from the front end of the front side 6a.

In other embodiments, the fastening elements 9b can be sewn into the side seams on the boundary between the front and the middle third of the cushion—as seen from the direction of the front side 6a—or of the cover 7 on the inner side 1a and the outer side 1b in such a manner that when they are folded over the cushion, they lie flush one on top of the other. In a further embodiment, the fastening elements 9b can also be designed in the binding variant.

In this embodiment according to the invention shown in FIG. 2, the support cushion is adapted to the length of the lower arm of the user, and thus, the hand protrudes slightly over the front side 6a of the support cushion and its upper side 2, or the end joints of the fingers grasp the front side 6a of the support cushion.

FIGS. 3 and 4 show two plastic depictions of the support cushion according to the invention, in which in the centre, the recess 3 and bordering on both sides of it, the bulges 5a and 5b, can be identified. In FIG. 4, the Velcro fastening 11 can also be seen.

Other, in particular therapeutic or anatomical, adapted forms are also possible.

### LIST OF REFERENCE NUMERALS

1a Inner side
1b Outer side
2 Upper side
3 Recess
4 Central seam
5a, 5b Bulges
6a Front side
6b Rear side
7 Cover
8 Edge
9a, 9b Fastening element(s)
11 Velcro fastening
12 Cushion filling
13 Surface

1. A support cushion for supporting a lower arm of a patient, including an elbow and a hand, on a therapy table or an arm rest of a wheelchair, comprising:
an inner side facing towards a body of said patient having a concave shape;
an outer side facing away from said body of said patient having a convex shape; and
an upper side having a central seam that forms a recess, wherein the recess is bordered by side bulges.

2. The support cushion according to claim 1, wherein the central seam is curved towards the inner side.

3. The support cushion according to claim 1, wherein the support cushion is arrangeable on a solid surface of said therapy table or said arm rest affixed to said wheelchair.

4. The support cushion according to claim 1, wherein the cushion is adapted to said lower arm, including said elbow and said hand, of said user with regard to one or more of its dimensions including length, breadth, and height.

5. The support cushion according to claim 1, wherein the support cushion on a part of the upper side that holds said elbow of said user has a narrower rear side that differs from the rest of the support cushion, or on the part of the upper side that holds said lower arm of said user, has a broader front side that differs from the rest of the support cushion.

6. The support cushion according to claim 1, wherein the support cushion is designed as an inner cushion with a separate cover, wherein the central seam is arranged on the inner cushion or the support cushion without a cover.

7. The support cushion according to claim 1, wherein on the support cushion, at least one fastening element is arranged, which is firmly connected on a rear side or on an edge of the outer side to the inner cushion or the cover.

8. The support cushion according to claim 1, wherein on the support cushion, at least two fastening elements are arranged, which are respectively firmly connected to edges of the inner and outer side of the front side of the support cushion or to the cover.

9. The support cushion according to claim 1, wherein at least one fastening element is designed as a strip with or without a Velcro fastener, or the strip consists of material.

10. The support cushion according to claim 1, wherein the material on one or more of the outer side of the inner cushion and the cover includes one or more of cotton, molton cotton, is sewn with PE thread, is breathable, and is trimmed on the edges, and that the material of the cushion filling includes one or more of polystyrene micro-beads, spelt, and polyester flock.
